(19) United States
(12) Patent Application Publication
(10) Pub. No.: US 2006/0163175 A1
(43) Pub. Date: Jul. 27, 2006

(54) Process and an apparatus for puritification of waste oil or re-refined oil from mineral or synthetic oil

(75) Inventor: Kim Brogarrd Wiese, Herlev (DK)

Correspondence Address: Cooper & Dunham, 1185 Avenue of the Americas, New York, NY, 10036, US

(73) Assignee: Oilcare Holding Aps, A corporation of Denmark, Farum (DK)

(21) Appl. No.: 10/518,037

(22) PCT Filed: Apr. 11, 2003
(86) PCT No.: PCT/DK03/00246

§ 371 Date: Dec. 10, 2004

Related U.S. Application Data
(60) Provisional application No. 60/389,003, filed on Jun. 14, 2002.

(30) Foreign Application Priority Data
Jun. 14, 2002 (DK) PA200200907

(51) Int. Cl. C02F 1/00

(52) U.S. Cl. 210/774

(57) ABSTRACT

The present invention relates to a process and an apparatus for the purification of waste oil or re-refined oil from mineral or synthetic oil. The process comprises the steps of prefiltration of the oil followed by passing the prefiltrated oil through a filtering unit in which the filter medium comprises organic fibres and carbon particles, said organic fibres and carbon particles being adhered to each other by a binder. By performing the process the waste oil is purified and hydrogen sulfide and residues from carbonization are effectively removed. Problems concerning blocking of the filters are reduced and the process is carried out in a continuous way resulting in a continuous flow.

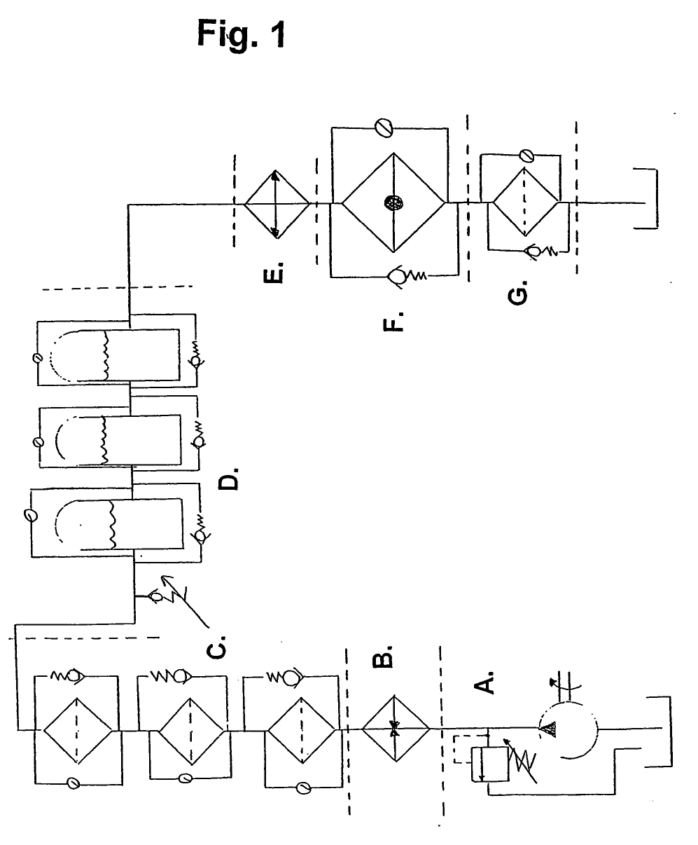

### TECHNICAL FIELD OF THE INVENTION

The present invention relates to a process and an apparatus for the purification of waste oil from mineral or synthetic oil. The present invention relates further to the use of an apparatus for purification of waste oil from mineral or synthetic oil.

### BACKGROUND OF THE INVENTION

Mineral or synthetic oil which has been used for example in the automobile industry or in other industries is traditionally treated in a re-refining process. After the re-refining of waste oil an oil product containing several waste materials is obtained. The waste material which comprises several residues from additives and from oxidation of oil in the re-refining process includes hydrogen sulfide and soot giving the oil a dark colour and a strong and unpleasant smell. Conventionally the oil product is used as a low-budget fuel which, because of the content of waste material, can cause environmental problems in the burning process of the fuel. It is therefore desirable to remove the waste material from the oil and to purify the oil in order to avoid the environmental problems.

The following patents relate to the purification of oil by using filters:

U.S. Pat. No. 4,988,440 relates to a filtering unit for cleaning hot cooking oil. The filtering unit contains activated carbon, calcium and/or magnesium silicate, cellulosic fiber and a binder. The hot cooking oil is decolorized, and odour causing components from the oil are adsorbed by using the filter. The purpose of the silicates is to remove free fatty acids from the oil.

EP patent 0 381 355 relates to a method and an apparatus for filtering hot cooking oil, in particular a method and an apparatus for straining the oil by passing it under a relatively low positive pressure through a filter pad of substantially uniform thickness and pore openings held in a pressure chamber. The filter pad includes fibrous material and activated carbon held by a resin binder.

JP 09 220415 relates to a filter for filtering edible oil. The filter consists of cellulose fibre, activated clay, binder and active carbon.

GB 2 080 350 relates to an edible oil regenerating membrane for household use or small scale business use. The membrane regenerates deteriorated oil by absorbing and filtering off impurities produced as a result of deterioration of the used frying oil.

The above-mentioned prior art relates to filtering of cooking and edible oil and not to filtering mineral or synthetic oil. The filters as described in the above-mentioned prior art are not useful for filtering mineral or synthetic oil or filtering waste oil from mineral or synthetic oil, as the components, which create odour and discoloration and which are desired to be removed from the oil, are likewise different. In the cooking and edible oil it is desired to remove products of oxidation and free fatty acids, whereas in the waste oil from mineral or synthetic oil it is intended to remove hydrogen sulfide and soot.

U.S. Pat. No. 6,321,915 relates to a filter medium which comprises a blend of activated carbon containing inorganic fibers, inorganic fiber whiskers and a binder. The filter medium can be used for removing unwanted species and particles from industrial oils. The inorganic fibers, however, have shown not to be useful for removing smelly components and colour.

Filters as described in U.S. Pat. No. 6,321,915 would not also be useful because of a fast blocking of the filters with necessary often change of the filter cartridge as a consequence.

Accordingly, there remains a need for a process and an apparatus for the purification of waste oil from mineral or synthetic oil, which process and apparatus do not exhibit the above-identified drawbacks.

The object of the invention is to provide a simple process by which the waste oil from mineral or synthetic oil is purified into a product devoid of smell and colour and by which process problems concerning blocking of the filters are reduced.

The object is also to provide a process which can be carried out in a continuous way resulting in a continuous flow.

The object of the invention is furthermore to present an apparatus which is useful in the process.

These objects are achieved by using the process and apparatus according to the invention as defined in the claims.

### DESCRIPTION OF THE INVENTION

In a first aspect the invention relates to a process for purification of waste oil from mineral or synthetic oil comprising the steps of:
prefiltrating said oil,
passing said oil through a filtering unit in which the filter medium comprises organic fibres and carbon particles, said organic fibres and carbon particles being adhered to each other by a binder.

The mineral or synthetic oil is preferably forced through the treatment steps by the use of a pump. By mineral or synthetic oil is meant any class of oils that are of mineral or synthetic origin, respectively.

The mineral or synthetic oil to be purified contains particles and smelly components. The particles give the oil a dark colour, and the smelly components give the oil a strong rotten and burnt smell. The product has so far been considered a kind of waste product only useful as a fuel. Still the product has a content of a valuable raw material.

By the process according to the invention the particles and the smelly components are separated from the oil, as the oil is purified. Hydrogen sulfide and residues from carbonization are effectively removed. The product obtained by using the process according to the invention is a raw material, a basic (virgin) oil.

The prefiltration of the oil is essential to achieve an optimal effect in the following filtering unit and also to achieve a process with a continuous flow.

By prefiltrating the oil most of the soot particles are removed. The prefiltrated oil is passed through a filtering unit in which the rest of the particles and also substances causing odour are removed resulting in a basic (virgin) oil product. Because of the prefiltrating treatment the lifetime of the last filtering unit is prolonged and a relatively more effective removal of the substances causing odour is obtained. This is due to the fact that a relatively larger part of the carbon particles in the filter can be used in the removal of the substances causing odour and colour.

The prefiltration of the oil can be carried out in one or more steps. By carrying out the prefiltration of the oil in more steps, it has the effect of increasing the overall prefiltering effectivity, since the probability of trapping a particle is increased by using more filters. It is furthermore an option to choose the prefiltration units so that they trap particles with decreasing sizes in the direction of the flow. This results in an extended lifetime of the prefilters because the period of time, until blocking occurs, is prolonged providing a better economy for the process.

One prefiltration step may be used in situations with particles of a known uniform size.

Depending on the composition of the waste material from mineral or synthetic oil, the oil is prefiltrated by passing the oil through one or more prefiltration units.

In a preferred embodiment of the invention the oil is prefiltrated by passing it through three prefiltration units. Depending on the sizes of the particles in the oil the filters that trap particles of the relevant size can be chosen. For example the prefiltration units can have the following characteristics: A first prefiltration unit trapping particles with a diameter bigger than the order of magnitude of 12 μm, a second prefiltration unit trapping particles with a diameter bigger than 6 μm and a third prefiltration unit trapping particles with a diameter bigger than 1 μm. This embodiment has shown to result in a very good economy for the process. The filtering material in these units may be made of different kinds of fibres for example glass fibres, cellulose fibres and fibres made of polymeric materials.

After prefiltrating the oil, the prefiltrated oil is passed through a filtering unit. Depending on the composition of the waste oil from mineral or synthetic oil, the oil may be passed through one or more filtering units.

The filter unit consists of a filter medium which comprises organic fibres and carbon particles adhered to each other by a binder. The filtering medium in the filtering unit preferably contains 5-95% carbon based on the weight of carbon particles and organic fibres. This type of filter medium has shown to result in a very high degree of purification towards smell and colour in waste oil from mineral or synthetic oil.

The filter medium can be produced by mixing carbon particles, fibres and binder followed by stirring in deionized water until a suitable consistency is achieved. Then the material is poured on a grating to drain off the water, and the material is equally distributed by vibration and compression. The material is punched in the desired form, for example in a circular form, and is now a filtering plate ready for use. By plate is meant a piece of material of which the thickness is small compared to the length and width. Such a filtering plate is easy to handle and the replacement of the plates is easily done as well.

The filter medium is optionally equipped downstream with a net of supporting material. By a net is meant any reticulated piece of material. The purpose of the net is to hold back the material of the filter medium if relatively high pressure is applied. For example the net is made of a polymeric plastic or steel. A net of polymeric plastic has the advantage that the entire filter medium is capable of being burnt after use.

As mentioned above the filter medium comprises organic fibres and carbon particles, wherein the organic fibres and carbon particles are adhered to each other by a binder.

The term “binder” comprises any material which is capable of holding the fibres and the carbon particles together with adhesive forces. For example the binder can be a resinous compound. Preferably the binder is a positively charged resin. A resin comprises any semi-solide or solid organic compound or mixture of organic compounds being sticky at certain temperatures. The positively charged resin gives a positive charge to the fibre material implying a more effective attraction of the waste materials.

By organic fibres are meant fibres originating from naturally occurring materials or fibres of synthetic polymeric materials. By the term “natural” is meant any fibre that originates from plant materials. Cellulosic fibres originating from wood, cotton or linen are suitable natural fibre materials and filter medium consisting of cellulosic fibers, carbon particles and a binder has shown to give a very high degree of purification. By synthetic fibres is meant any fibre which is synthetically produced. The synthetic fibres include fibres from polymeric material.

Carbon particles include carbon in crushed, pulverized, powderized form or carbon in any other particle-like form.

In one preferred embodiment of the invention the oil is passed through one or more vacuum units after being passed through the prefiltration units and before passing through the filtering unit. This is particularly useful, when the oil contains free gases. In these units subatmospheric pressure exists, and free gases are liberated. In the filtering unit the residual waste products can be even more effectively removed since the free gases are already removed and thus do not take up capacity in the filtering unit.

In a second preferred embodiment the oil before being prefiltrated is heated to a temperature of 50-90° C. The heating results in lowering the viscosity of the oil which may help keeping a high lifetime of the prefiltrating filters. If the starting oil is a low-viscosity oil, said heat treatment is not necessary. Another effect of the heating is that any free gases are released more easily in the vacuum units.

If the oil is in a heated condition when it reaches the filtering unit it is advantageous to pass the oil through a cooling unit before the end of the purification. Preferably the cooling unit is placed immediately before entering the filtering unit. The cooled oil is of a higher viscosity and the retention time in the filtering unit is therefore extended causing a more effective adsorption of the smelly components to the carbon particles in the filter. Preferably the oil is cooled to a temperature of 10-30° C.

After passing the filtering unit the oil may optionally be passed through an additional filter unit. The purpose of this unit is to trap any residues of carbon escaping from the filtering unit.

In a second aspect the present invention relates to an apparatus for the purification of waste oil from mineral or synthetic oil comprising
means for prefiltrating the oil and
a filtering unit in which the filtering medium comprises organic fibres and carbon particles, said organic fibres and carbon particles being adhered to each other by a binder.

The apparatus according to the invention may preferably comprise a pump preferably for forcing the mineral or synthetic oil through the treatment steps. The apparatus according to the invention comprises means for prefiltrating the oil and a filtering unit. By means for prefiltrating is meant any type of filter known in the art which can prefiltrate the waste oil from mineral or synthetic oil.

In one preferred embodiment according to the invention the apparatus comprises a heater which is placed in the direction of the flow immediately before the prefiltrating means. The heating results in lowering the viscosity of the oil which may help keeping a high lifetime of the prefiltrating filters.

In a second preferred embodiment of the invention the apparatus comprises a cooler which is placed in the direction of the flow immediately before the filtering unit. The oil is cooled by the cooler, and the cooled oil is of a higher viscosity and the retention time in the filtering unit is therefore extended causing a more effective adsorption of the smelly components to the carbon particles in the filter.

In a third preferred embodiment of the invention the apparatus comprises an additional filter, said filter being placed in the direction of flow after the filtering unit.

The present invention relates in a third aspect to the use of an apparatus for the purification of the waste oil from mineral or synthetic oil.

### DESCRIPTION OF THE DRAWING

The drawing shows a flow diagram of a preferred embodiment of the invention.

A preferred embodiment of the process is shown in the drawing. The letters of the drawing refer to the following steps:
A. Pump
B. Heater
C. Prefiltration
D. Vacuum towers
E. Cooler
F. Filtering unit
G. Additional filter

It is to be understood that only C and F are essential steps, the rest is optional to be decided in accordance with the specific purification problem. The oil is pumped by a displacement pump (A) equipped with a check valve in order to regulate the pressure. The oil is optionally passing through a heater (B) in which the oil is heated to a temperature of 50-90° C. resulting in a low-viscosity oil prolonging the lifetime of the filters in the following prefiltration steps.

The heated oil is now passed to the prefiltration step (C). In the embodiment of the invention shown on the drawing the prefiltration step comprises three prefiltration units. Each unit may be supplied with a by-pass valve. The first unit traps the particles bigger than the order of magnitude of 12 μm, the second unit traps the particles bigger than 6 μm and the third unit traps particles bigger than 1 μm. In this way the lifetime of the filter medium in the prefiltrating units is extended.

Any number of prefiltration filters and sizes of the voids in the filters may be chosen in accordance with the specific purification problem.

From the prefiltration step the oil is passed on to three vaccum towers (D). Each unit is supplied with a by-pass valve. In the vacuum towers any free gases are released resulting in an even more effective removal of waste materials in the following filtering unit.

Optionally the oil is sent through a cooling step (E) giving a high-viscosity oil. The high-viscosity oil has a longer retention time in the following filtering unit providing a more effective removal of the waste products. From the cooler the oil is passed on to the filtering unit (F). In this unit the filtering medium comprising cellulosic fibres and carbon particles being adhered to each other by a positively charged resinous binder removes waste material including odour- and colour-causing components. The unit may be supplied with a by-pass valve.

The oil is now optionally passed on to an additional or security filter (G). In this filter any carbon material from the filtering unit that has been detached is trapped. The filter is supplied with a security valve. The product obtained by the process is a purified product devoid of smell and colour.

### EXAMPLE

The following example illustrates the present invention in a preferred embodiment:

A re-refined waste oil was purified by passing the oil through the treatment steps shown on the drawing. The oil was passed by the pump (A) through the heater (B) and from the heater the oil was passed through three prefiltration units (C). After this the oil was passed through three vacuum towers (D). Subsequently the oil was cooled in the cooler (E). The cooled oil was treated in the filtering unit (F). Finally the oil was passed through an additional filter (G). The content of particles, the colour level and the smell of the oil were measured/observed at the entrance, after the prefiltration units, after the vacuum towers and after the filtering unit. The following results were obtained:

| | | | After | After |
|---|---|---|---|---|
| | | After | vacuum | filtering |
| | Entrance | prefiltration | towers | unit |
| Level of | 21/19/17 or | 14/11/9 | 14/11/9 or | 14/11/9 or |
| particles | less | or less | less | less |
| (mean | | | | |
| values) | | | | |
| Level of | 3.5-4 or less | 3.2 or less | 3.2 or less | 0.5-1 or |
| colour | | | | less |
| (mean | | | | |
| values) | | | | |
| Smell | Strong rotten | Strong rotten | Less strong | Rotten and |
| | and burnt | and burnt | rotten and | burnt smell |
| | smell | smell | burnt smell | has |
| | | | | disappeared |

The numbers of particles are measured by using an automatic lazer particle counter of the type Met-one/Hiac Royco. The particle level is determined as specified in the international standard ISO 4406. This standard relates the numbers of particles to a level of contamination by particles. The three numbers refer to the level of particles with a diameter bigger than 2 μm, 5 μm and 15 μm, respectively.

The colour level is measured as specified in ISO 2049. The standard defines a method for the visual determination of the colour of oil products. For the determination it is required to have a sample in a container and a calorimeter. The container is placed in the calorimeter and a light source is switched on to illuminate the sample. The sample is now compared to colour standards. It is determined which standard matches the colour of the sample best. The result is noted as an identification number of the standard matching the sample best.

The smell has been subjectively judged by shaking the sample of oil, removing the lid of the sample container and smelling the sample of oil.

From the example it appears that the oil is freed from smelly components and is practically colourless.

1. A process for purification of waste oil or re-refined oil from mineral or synthetic oil comprising the steps of:
prefiltrating said oil,
lowering the temperature of the prefiltrated oil and subsequently passing the prefiltrated oil through a filtering unit in which the filter medium comprises organic fibres and carbon particles, said organic fibres and carbon particles being adhered to each other by a binder.

2. A process according to claim 1, wherein the oil is prefiltrated by passing the oil through one or more prefiltration units.

3. A process according to claim 1, wherein the oil is prefiltrated by passing the oil through three prefiltration units.

4. A process according to claim 3, wherein the first prefiltration unit is trapping particles bigger than approximately 12 μm, the second prefiltration unit is trapping particles bigger than approximately 6 μm, and the third prefiltration unit is trapping particles bigger than approximately 1 μm.

5. A process according to claim 1, wherein the prefiltration units remove particles with decreasing sizes in the direction of the flow.

6. A process according to claim 1, wherein the prefiltration is performed by using a filtering medium made of glass fibres.

7. A process according to claim 1, wherein the prefiltrated oil is passed through one or more filtering units.

8. A process according to claim 1, wherein the filtering medium in the filtering unit contains 5-95% carbon based on the weight of carbon particles and organic fibres.

9. A process according to claim 1, wherein the fibres in the filtering unit are natural fibres.

10. A process according to claim 1, wherein the binder is a positively charged resin.

11. A process according to claim 1, wherein the organic fibres, the carbon particles and the binder are in the form of a filtering plate.

12. A process according to claim 11, wherein the filtering plate is supported downstream by a net.

13. A process according to claim 1, wherein the oil is passed through one or more vacuum units after passing through the prefiltration units and before passing through the filtering unit.

14. A process according to claim 1, wherein the oil is heated to a temperature of 50-90° C. before passing the prefiltration units.

15. A process according to claim 1, wherein the oil is cooled immediately before passing through the filtering unit.

16. A process according to claim 15, wherein the oil is cooled to a temperature of 10-30° C.

17. A process according to claim 1, wherein the oil is forced through the treatment steps by the use of a pump.

18. An apparatus for the purification of waste oil or re-refined oil from mineral or synthetic oil by a process according to claim 1, comprising
means for prefiltrating said oil,
means for cooling the prefiltrated oil and a filtering unit in which the filtering medium comprises organic fibres and carbon particles, said organic fibres and carbon particles being adhered to each other by a binder.

19. An apparatus according to claim 18, wherein the filtering medium in the filtering unit contains 5-95% carbon based on the weight of carbon particles and fibres.

20. An apparatus according to claim 18, wherein the fibres in the filtering unit are natural fibres.

21. An apparatus according to claim 18, wherein the binder is a positively charged resin.

22. An apparatus according to claim 18, wherein the organic fibres, the carbon particles and the binder are in the form of a filtering plate.

23. An apparatus according to claim 22, wherein the filtering plate is supported downstream by a net.

24. An apparatus according to claim 18, wherein said means for prefiltrating comprises one or more prefiltration units.

25. An apparatus according to claim 24, wherein said prefiltration units remove particles with decreasing size in the direction of the flow.

26. An apparatus according to claim 18, wherein the prefiltration means comprise three prefiltration units.

27. An apparatus according to claim 26, wherein the first unit is trapping particles bigger than approximately 12 μm, the second prefiltration unit is trapping particles bigger than approximately 6 μm, and the third prefiltration unit is trapping particles bigger than approximately 1 μm.

28. An apparatus according to claim 18, wherein the prefiltrating means comprise filters with a filter medium made of glass fibres.

29. An apparatus according to claim 18, wherein said apparatus comprises one or more vacuum units, said vacuum units being placed in the direction of the flow immediately after the prefiltrating means.

30. An apparatus according to claim 18, wherein a heater is placed in the direction of the flow immediately before the prefiltrating means.

31. An apparatus according to claim 18, wherein a cooler is placed in the direction of the flow immediately before the filtering unit.

32. An apparatus according to claim 18, comprising an additional filter, said filter being placed in the direction of flow after the filtering unit.

33. An apparatus according to claim 18, comprising a pump preferably for forcing the oil through the treatment steps.

34. Use of an apparatus according to claim 18, for the purification of waste oil or re-refined oil from mineral or synthetic oil.

35. A process according to claim 1 wherein the filters in the filtering mix are cellulose fibres.

36. A process according to claim 11, wherein the filtering plate is supported downstream by a net of plastic or steel.

37. An apparatus according to claim 18, wherein the filters in the filtering mix are cellulose fibres.

38. An apparatus according to claim 22, wherein the filtering plate is supported downstream by a net of plastic or steel.
